(19) United States
(12) Patent Application Publication
(10) Pub. No.: US 2026/0210466 A1
(43) Pub. Date: Jul. 23, 2026

(54) FLUID CONTROL

(71) Applicant: MIKK Valve Holdings Limited, Sussex (GB)

(72) Inventors: Angus Walker, Sussex (GB); Robin Gale, Sussex (GB)

(21) Appl. No.: 19/157,838

(22) PCT Filed: Feb. 20, 2024
(86) PCT No.: PCT/EP2024/054326

§ 371 Date: Aug. 19, 2025

(30) Foreign Application Priority Data
Feb. 20, 2023 (GB) 2302415.1

(51) Int. Cl. F16L 29/04; F16L 15/02; F24D 19/00

(52) U.S. Cl. CPC F16L 29/04; F16L 15/02; F24D 19/0075

(57) ABSTRACT

The present invention relates to fluid control and management, particularly to valves and regulators for controlling the flow of a liquid, such as water. We described an isolating valve assembly comprising a first isolating valve demountably fluidly couplable to a second isolating valve. The first isolating valve comprises a first valve body and the second isolating valve comprises a second valve body demountably attachable to the first valve body. The first and second valve bodies each includes a respective valve comprising a valve plug and a valve seat against which the valve plug bears to prevent flow of fluid through the valve body when the first valve body and second valve body are in disconnected configuration. At least one of the valve plugs includes an axial actuator stem arranged such that, when the second valve body is attached to the first valve body, the axial actuator stem bears against the other valve plug to cause both valves to open.

The present invention relates to fluid control and management. In particular, it relates to valves and regulators for controlling the flow of a liquid, such as water.

In our earlier application, WO 2015/193666, we described a valve, particularly a tap or faucet. The tap consists of two parts, a base portion having a non-return valve biased into a closed position under pressure of water; and a tap body having a generally conventional construction including a conventional valve and further including a valve actuator, in the form of a stem. The tap body is demountable to the base portion. The tap body has a first configuration in which, in the assembled tap, the conventional valve of the tap body bears against the valve actuator which, correspondingly, bears against the non-return valve, urging it into an open configuration and allowing water to flow. The tap body has a second configuration in which the valve of the tap body contacts the valve actuator to a degree insufficient to cause opening of the non-return valve; and a third configuration in which the valve of the tap body is spaced from the valve actuator. In the third configuration, the tap body may be demounted from the base portion without risking flow of water. The tap body may then be replaced or repaired, without the need to shut off the water supply.

WO 2015/193666 also describes that the valve is suitable for adoption for other purposes, such as radiator valves and any other field in which control over flow of a fluid is required.

In its broadest sense, in a first aspect, the present invention provides an isolating valve assembly comprising a first isolating valve demountably fluidly couplable to a second isolating valve, wherein the first isolating valve comprises a first valve body and the second isolating valve comprises a second valve body demountably attachable to the first valve body; wherein the first valve body and the second valve body each includes a respective valve comprising a valve plug and a valve seat against which the valve plug bears to prevent flow of fluid through the valve body when the first valve body and second valve body are in a disconnected configuration; wherein at least one of the valve plugs includes an axial actuator stem arranged such that, when the second valve body is attached to the first valve body, the axial actuator stem bears against the other valve plug to cause both valves to open.

In preferred embodiments, only one of the valve plugs includes an axial actuator stem.

In preferred embodiments, each of the first and second valve bodies includes a biassing means to bias the valve plug into a closed position against its respective valve seat.

Optionally, the biassing means includes a compression spring.

In certain embodiments, the isolating valve assembly further comprising coupling means for coupling the valve to a fluid line.

Optionally, the coupling means comprises a compression fitting and/or a push-fit connector.

Advantageously, each valve plug includes a valve guide stem for guided axial movement within a respective valve body.

In some embodiments, the first valve body is attachable to the second valve body by means of a threaded coupling or a bayonet-type coupling.

In certain examples, each valve plug further comprises retaining means to retain the valve plug within the valve body.

Optionally, the isolating valve assembly further comprising at least one cap associated with the first valve body and/or the second valve body, wherein the or each cap provides a cover to prevent access to the respective valve plug when the isolating valve is in the disconnected configuration.

In certain embodiments, at least one of the first and second valve bodies includes a valve body having an adjustment arrangement allowing adjustment of an axial length of the valve body.

In preferred embodiments, the adjustment arrangement comprises: i) a cylindrical first valve body portion including an annular detent provided on a threaded inner surface of the first valve body portion dividing the threaded surface into a proximal thread portion and a distal thread portion; ii) a second valve body portion having a threaded outer surface, threads of which inter-fit the distal threads of the first valve body portion such that the second valve body portion is rotationally movable within first valve body portion to provide axial length adjustment to the second valve body; and iii) a cylindrical valve-housing portion supporting the valve plug of the second valve and including a recess on an external surface thereof into which the annular detent fits to maintain a relative axial positioning between the valve housing portion and the first valve body portion; wherein adjacent outer surface of valve housing portion are unthreaded such that the respective surfaces are able, in operation, to slide over one another.

In a second aspect, the present invention provides a radiator valve assembly comprising a radiator valve body having an inlet and an outlet and including a radiator valve adjustable between a closed position in which fluid flow through the valve body is prevented and at least one open position in which fluid flow through the valve body is allowed; wherein the radiator valve further comprises at least one isolating valve assembly as defined above.

Optionally, the isolating valve assembly is provided between the adjustable radiator valve and the radiator, or incorporated into a radiator connection tail or coupler.

In a third aspect, the present invention provides a connector for connecting two pipes or lines, wherein the connector comprises a first connector portion attachable to a first pipe or line and a second connector portion attachable to a second pipe or line, wherein the first connector portion and second connector portion are connectable to complete a connection between the first and second pipes or lines; wherein the second connector portion includes an adjustment arrangement allowing adjustment of an axial length of the connector; wherein the adjustment arrangement comprises: i) a cylindrical first body portion including an annular detent provided on a threaded inner surface of the first body portion dividing the threaded surface into a proximal thread portion and a distal thread portion; ii) a second body portion having a threaded outer surface, threads of which inter-fit the distal threads of the first body portion such that the second body portion is rotationally movable within first body portion to provide axial length adjustment to the second connector portion; and iii) a cylindrical portion including a recess on an external surface thereof into which the annular detent fits to maintain a relative axial positioning between the cylindrical portion and the first body portion; wherein adjacent outer surfaces of the cylindrical portion and second body portion are unthreaded such that the respective surfaces are able, in operation, to slide over one another.

The above and other aspects of the present invention will now be described in further detail, by way of example only, with reference to the accompanying figures, in which:

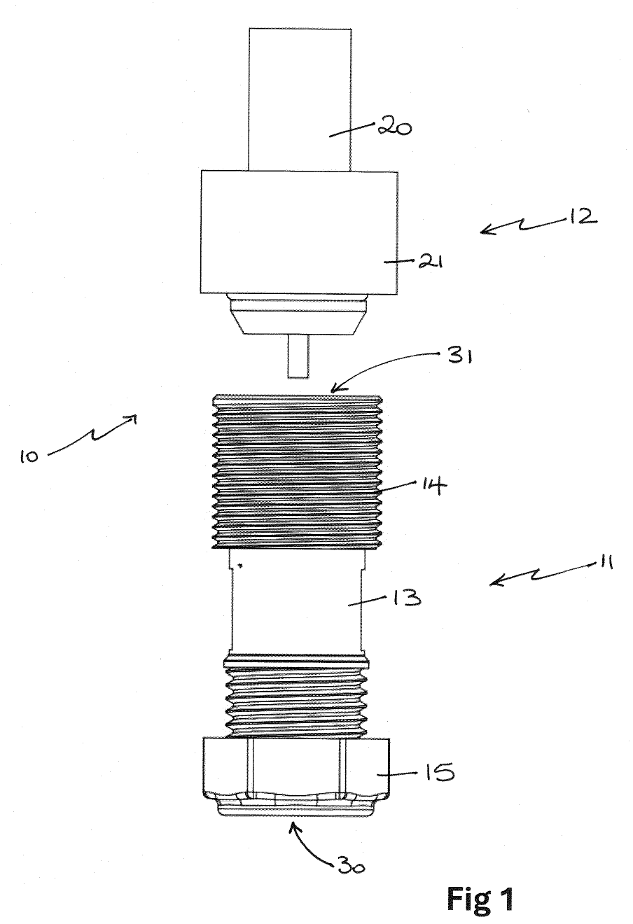

FIG. 1 is a side view of a first embodiment of an isolating valve in accordance with the present invention, in a de-coupled configuration;

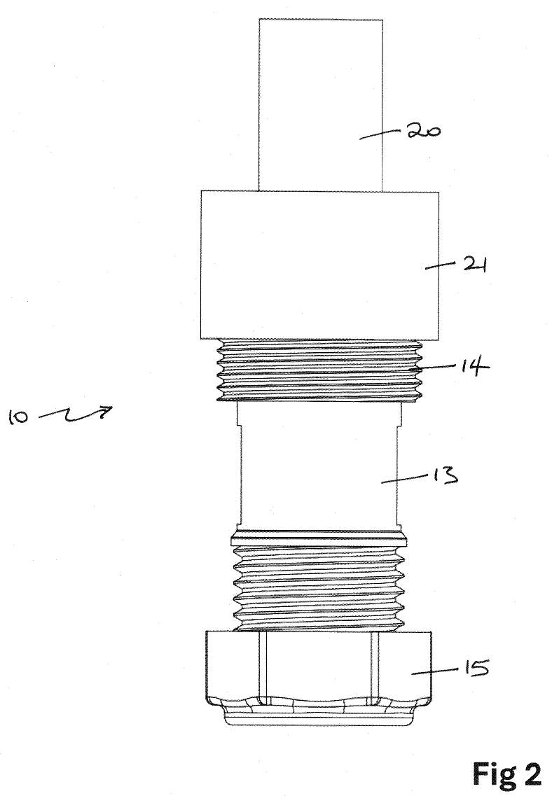

FIG. 2 is a side view of the embodiment of FIG. 1 in a coupled configuration;

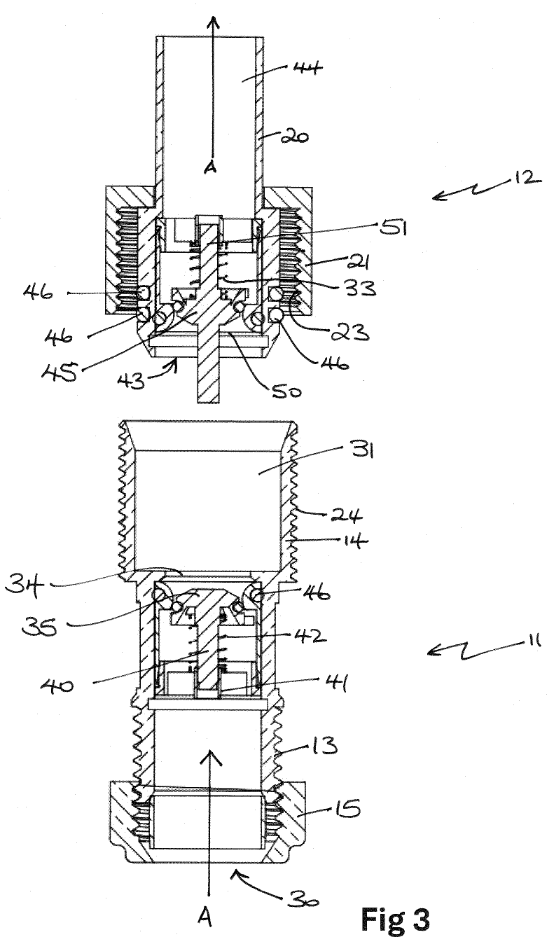

FIG. 3 is a cross-sectional view corresponding with FIG. 1;

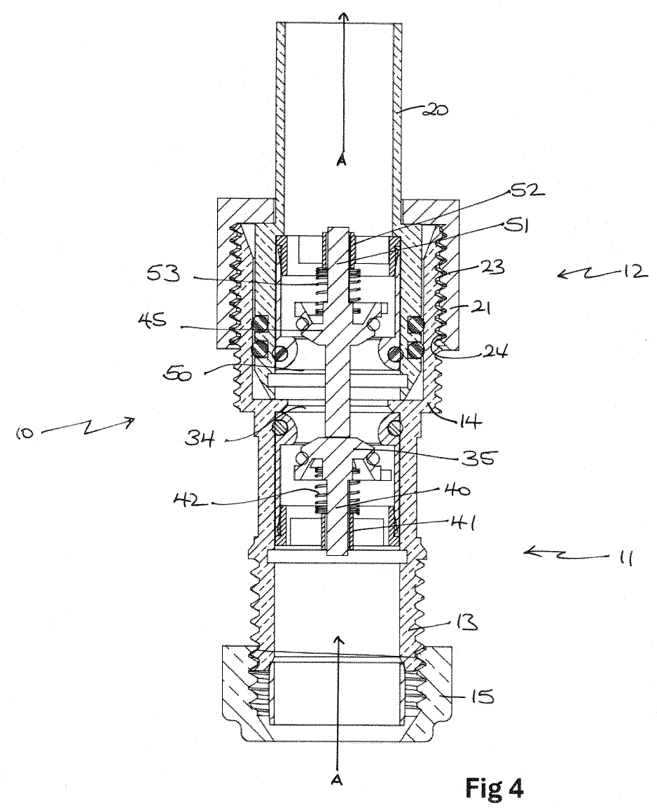

FIG. 4 is a cross-sectional view corresponding with FIG. 2;

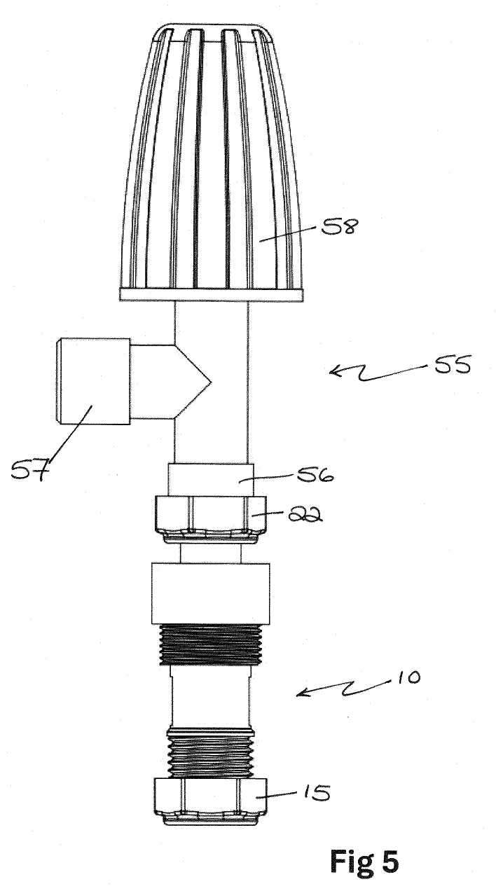

FIG. 5 is a perspective view illustrating coupling of the isolating valve of FIG. 1 to a radiator valve; and

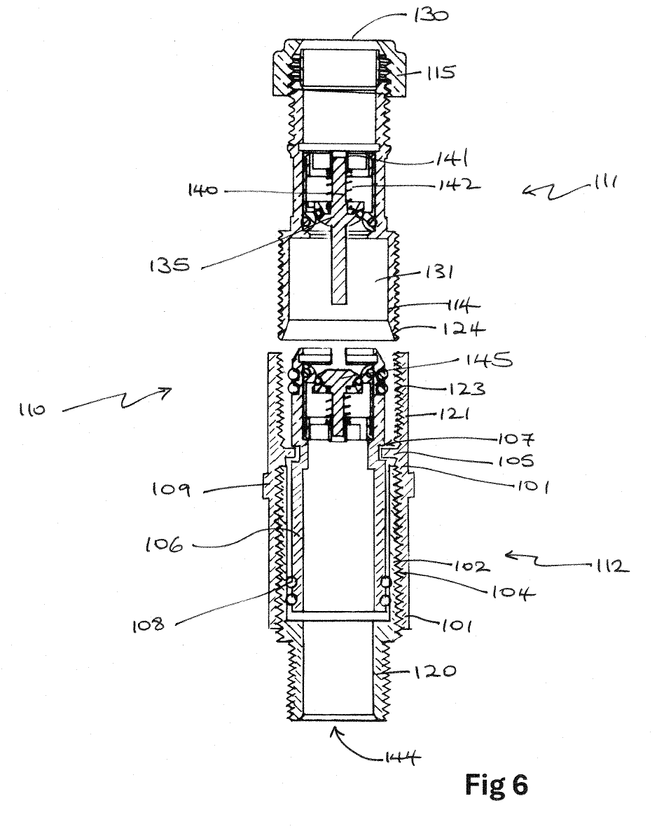

FIG. 6 is a partial cross-sectional view of a second embodiment of an isolating valve in accordance with the present invention, in a de-coupled configuration.

With reference to FIGS. 1 to 5, there is shown a first embodiment of an isolating connector or valve assembly 10 in accordance with the first aspect of the present invention. The valve assembly 10 has a first valve comprising a first valve body 11 and a second valve comprising a second valve body 12 couplable to the first valve body to form the isolating connector in a configuration allowing fluid flow through the valve 10 and demountable therefrom to prevent flow from both valve bodies.

First valve body 11 includes a tube or pipe 13 having, at a proximal end thereof, a first coupling component 14 and, in the embodiment shown, at a distal end thereof, a compression fitting 15 for operative coupling to a pipe (not shown) of a fluid installation in which the isolating valve is intended to be used.

Second valve body 12 includes a tube or pipe 20 having, at a proximal end thereof, a second coupling component 21 as will be described further below. Pipe 20 forms a tail for operative connection to a further portion of pipe or a connector (not shown) of the fluid installation, for example, by means of a compression fitting comprising an olive and compression nut (not shown), an end-feed solder fitting, or a push-fit type connector. In some examples, the tail is provided with a thread for coupling to a further component of the fluid installation.

Pipes 13, 20 are shown as being straight and having a short length. It will be appreciated that each may, alternatively, form an elbow, such as a 90° elbow, or have any other configuration and length, as may be useful to achieve a particular function or installation, as will be familiar to the skilled person.

First and second coupling components 14,21 are generally cylindrical and form a mating pair at their respective proximal ends with, in the embodiment shown, second coupling component 14 having an internally-threaded surface 23 (FIGS. 3 and 4) which mates with a correspondingly threaded external surface 24 (FIG. 4) on first coupling component 21. FIGS. 1 and 3 show first and second valve bodies 11,12 in an uncoupled configuration. FIGS. 2 and 4 show the two valve bodies in a coupled configuration.

The isolating connector and valve assemblies of the present invention are bi-directional. That is to say, they can be coupled to a fluid installation in either orientation. For the purposes of the following explanation, however, a flow direction shown by arrow A will be presumed.

First valve body 11 has a distal inlet 30 and a proximal outlet 31 associated with first coupling component 14, defining, with pipe 13, a first fluid flow path. Located within the first fluid flow path is a first valve including a first valve plug 35 which bears, in use, against a valve seat 34, closing the flow of fluid through first valve body 11. In the embodiment shown, valve seat 34 and valve plug 35 has generally conical or frusto-conical sealing surfaces. Other arrangements will be apparent to the skilled person. Valve plug 35 is formed with a distal valve guide stem 40 constrained within an axial sleeve 41 for axial movement between a fluidly closed position, as shown in FIG. 3, in which flow of fluid through the first valve body is prevented, and a fluidly open position, as shown in FIG. 4, in which flow of fluid is permitted. Valve guide stem 40, and thus valve plug 35, is biased into the closed position by means of a compression spring 42.

Valve plug 35 is also formed proximally with an axial actuator stem 43, the function and operation of which will be described below.

Second valve body 12 has a broadly similar construction and has a proximal inlet 43 associated with second coupling component 21 and a distal outlet 44 defining, with pipe 20, a second fluid flow path. Located within the second fluid flow path is a second valve, including a second valve plug 45 which bears, in use, against a valve seat 50, closing the flow of fluid through the second connector component 12.

The valve seat 50 and valve plug 45 have, in the embodiment shown, generally conical or frusto-conical sealing surfaces.

Second valve plug 45 is formed with a distal valve guide stem 51 constrained within an axially-aligned aperture 52 for axial movement of the valve plug 45 between a fluidly closed position, as shown in FIG. 3, in which flow of fluid through the first connector component is prevented, and a fluidly open position, as shown in FIG. 4, in which flow of fluid is permitted. Valve guide stem 51, and thus second valve plug 45, is biased into the closed position by means of a compression spring 53.

The first and second valve bodies 11,12 further include such bearing surfaces as are necessary for the function of the components described and include apertures in such surfaces to allow flow of fluid through the valve 10 when assembled.

As can be seen in FIG. 3, when the first and second valve bodies 11,12 are detached from each other, both valves are biased by their respective compression springs 42,53 into their respective closed positions.

As also can be seen in FIG. 3, the valve assembly may include O-ring seals 46 or other sealing means as appropriate to ensure no fluid leakage between component surfaces. Sealing means may be made of any material suitable to the application and fluidic environment in which the valve assembly is to be used. Such materials may include rubber, for example, vulcanised rubber, butyl or nitrile rubber, EDPM, neoprene, silicone rubber, or PTFE and similar polymers, or metallic rings, such as copper, nickel or indium.

As the first and second valve bodies 11,12 are brought together, concluding with the fully assembled configuration shown in FIG. 4, it can be seen that axial actuator stem 43 of the first valve contacts and then bears against the valve plug 45 of the second valve, compressing both compression springs 42,53. The components of the valve 10 are selected such that, when fully assembled, both valves are opened by the interaction between the axial actuator stem of the first valve and the valve plug of the second valve. There are several considerations which will have an impact upon the reliable provision of this feature, including a balance between the spring strengths of the two compression springs 42,53; the lengths of guide stems 40,51, compressed lengths of the compression springs 42,53.

Upon disconnection of the first and second valve bodies 11,12, as the bodies are moved apart, the biassing forces of the respective springs 42,53 will supplement forces associated with the pressure of fluid in the fluid line in which the isolating valve is installed, and act to close the respective first and second valves.

Second valve plug 45 provided, in preferred embodiments, with a cup 54 in a proximal face thereof to provide a reliable surface into which and against which axial actuator stem 43 may bear.

It will be appreciated that numerous variations and modifications may be made to the described and illustrated embodiment whilst remaining within the scope of the invention. For example, the axial actuator stem may be provided on either of first valve plug 35 or second valve plug 45. In certain embodiments, both valves may include an axial actuator stem portion. However, it will be noted, with particular reference to FIG. 3, that the arrangement of FIG. 3 has an advantage that axial actuator stem 43 is protected from causing opening of valve 34,35 through accidental contact with the stem 43 by the bulk of the body of male coupling component 14; and valve plug 45 of the second valve, by having no axial actuator stem or stem portion projecting from second valve body 11, is also protected from accidental opening caused by impact or contact with an external body. Accordingly, the arrangement shown in the figures represents a preferred embodiment of the present invention.

In certain embodiments, the valve assembly further includes a cap (not shown) fittable to at least one, or both, valve bodies to provide additional protection against accidental contact with the valve plugs when the valve assembly is in a disassembled configuration. Each cap is dimensioned to close off external access to the respective valve plug without providing a surface which can contact the valve plug or axial actuator stem or stem portion. Suitably, each cap is an injection-moulded plastics cap, adapted for attachment to a respective valve body by hand, without the need for any tools.

In further alternative embodiments, rather than the end of each valve body including a compression fitting 15,22, each end may include a push-fit connector, solder ring connector or threaded connection, for example.

FIG. 5 shows the assembled isolating valve assembly 10 of FIGS. 1 to 4 coupled to a conventional radiator valve 55 by means of fitting 22, typically a compression fitting using a compressible copper olive, coupling to the conventional threaded tail of the radiator valve 55. Modern radiator valves 55 are typically bi-directional such that they may be connected to either of the flow and return circuits of a heating system. For the purposes of illustration only, radiator valve 55 can be taken to include an inlet 56 coupled to the flow circuit of the heating system and outlet 57 connectable to a radiator (not shown). A body of radiator valve 55 includes a valve operable by means of a hand-adjustable or electrically-adjustable valve head 58, which may be of the lockshield or thermostatic type.

One isolating valve assembly of the present invention may be associated with each radiator valve such that if, for example, it is desired to remove the radiator, when decorating, for example, or to replace the valve 55, the first and second valve portions of the isolating valve assemblies of the present invention can be demounted from each other, causing the first and second valves to close under operation of the compression springs and allowing the radiator or the valve to be removed without having to drain water from the radiator or from the entire heating circuit.

It will be appreciated that, upon disassembly of the first and second valves of the isolating valve assembly, first valve body 11 will remain attached to the pipe of the heating circuit and second valve body will be attached to the radiator valve. The radiator can then be lifted vertically of its brackets and removed from the wall without having to be drained first, with both radiator valves still attached to the radiator.

In an alternative embodiment (not shown), a radiator valve is provided which includes an isolating valve assembly as described above positioned between the valve of the radiator valve (such as the thermostatically-controlled valve) and the radiator. In certain examples, threads 13 of the first valve body form the threads of the radiator connection tail, such that the first valve body is screwed into the body of the radiator. In other examples, the isolation valve is integrated into the radiator valve assembly. Upon disassembly of the first and second valves of the isolating valve assembly, the radiator valve remains attached to pipework of the heating system.

In certain installations, the pipework into which the isolating valve is to be used will be fixed in place such that there is insufficient movement available for separation of the first and second valve bodies. This is addressed by the third aspect of the present invention and embodiments which incorporate both the first and/or second aspects and the third aspect. FIG. 6 shows a second embodiment of an isolating valve in accordance with the present invention which additionally includes an axially-adjustable sleeve providing a slip joint or connection. Where the features of the isolating valve of FIG. 6 generally correspond with the features of the isolating valve of FIGS. 1 to 5, the same reference numerals are used, with the addition of 100 and will not be described in further detail other than is useful to an understanding of the second embodiment. For example, the valve assembly 110 has a first valve comprising a first valve body 111 and a second valve comprising a second valve body 112 couplable to the first valve body.

The first and second valve bodies 111,112 are couplable by means of first and second coupling components 114,121 as discussed above with respect to the first embodiment. However, in the embodiment of FIG. 6, second valve body 112 is formed of two valve body portions, interfitting to allow the length of the second valve body to be axially adjustable for length.

An internally-threaded cylinder defines a first valve body portion 101 and includes an annular detent 105 provided on an inner surface of the first valve body portion 101 dividing the threaded surface into a proximal thread 123, at that end of the cylinder adjacent valve plug 145 for engagement with threads of first coupling component 114, and a distal thread 103 at that end of the first valve body portion 101 which is remote the valve plug.

An externally-threaded cylinder defines a second valve body portion 102, the threads 104 of which inter-fit the distal threads 103 of the first valve body portion 101. Accordingly, second valve body portion 102 is rotationally movable within first valve body portion 101 to provide axial length adjustment to the second valve body 112 between the inlet and outlet of the second valve body 112.

The valve plug 145 and its associated features as described above in respect of the first embodiment, are supported within a cylindrical valve housing portion 106. Valve housing portion 106 has a recess 107 on an external surface thereof into which annular detent 105 slots to maintain the relative axial positioning between valve housing portion 106 and first valve body portion 101.

The inner surface of second valve body portion 102 and the adjacent outer surface of valve housing portion 106 are unthreaded such that the respective surfaces are able, in use, to slide over one another. One or more O-ring seals 108 are provided as appropriate.

The first valve body portion 101 is provided with flattened surfaces 109 to provide surfaces for engagement with a spanner.

In the example shown, inlet/outlet 144 is provided with a threaded outer surface 120 to which an olive and compression nut can be attached to form a compression fitting for an external pipe with which the isolator valve is to be used. Other modes of connection are equally suitable, as described above, such as soldered joints, push fit connections, and so on.

In the configuration shown in FIG. 6, the first and second valve bodies 111,112 are shown in a detached or disassembled configuration. To move the valve bodies to a coupled configuration, first valve body portion 101 is rotated with respect to second valve body portion 102 along respective threads 103,104. Engagement of detent 105 with recess 107 of valve housing portion 106 will cause valve housing portion 106 to move in concert with first valve body portion axially away from inlet/outlet 144 and towards first valve body 111. Internal proximal thread 123 of first valve body portion will engage external thread 124 of first valve body 111 and engagement will continue until the first valve body 111 is fully received within the second valve body 112 and the valve plugs are opened as described above with respect to the first embodiment and fluid is able to flow between the two valve bodies.

Disassembly is a reverse of the assembly procedure.

In certain embodiments, the isolating valve 10,110 may include a locking screw or bayonet nut or grub-screw to lock first and second valve bodies 11,12,111,112 together to reduce the risk of inadvertent disassembly.

Although illustrated in FIG. 5 as a radiator valve, it will be appreciated that the advantages of the isolating valves of the present invention can be achieved by incorporation of the isolating valve of the present invention into any fluid flow line, whether for liquid or gas, such as showers, taps or faucets, zone valves, diverter valves and so on and whether at atmospheric pressure or at elevated or reduced pressures. The isolating valve of the present invention is particularly useful as a means for isolating and allowing easy separation of components in scenarios involving electrically-powered equipment, which may have high servicing demands or be more prone to failure. For example, the isolating valve of the present invention is particularly useful in the installation of electrical devices which form part of a flowing fluid environment, such electric showers, allowing for detachment of pump units, and valve and pump units of smart showers, electrical hot or boiling water appliances; shower drain pumps; sump pumps; and water filter apparatus, especially in hard-water areas for example where the likelihood of failure or the need for regular servicing is greater.

It will also be appreciated that, typically, the isolating valve assemblies of the present invention will be used in pairs either side of a potentially removable or replaceable component, and that a series of multiple isolating valves may be used in any given installation, associated with a number of components of the system.

1. An isolating valve assembly comprising a first isolating valve demountably fluidly couplable to a second isolating valve, wherein the first isolating valve comprises a first valve body and the second isolating valve comprises a second valve body demountably attachable to the first valve body; wherein the first valve body and the second valve body each includes a respective valve comprising a valve plug and a valve seat against which the valve plug bears to prevent flow of fluid through the valve body when the first valve body and second valve body are in a disconnected configuration; wherein at least one of the valve plugs includes an axial actuator stem arranged such that, when the second valve body is attached to the first valve body, the axial actuator stem bears against the other valve plug to cause both valves to open.

2. An isolating valve assembly as claimed in claim 1 wherein only one of the valve plugs includes an axial actuator stem.

3. An isolating valve assembly as claimed in claim 1 wherein each of the first and second valve bodies includes a biassing means to bias the valve plug into a closed position against its respective valve seat.

4. An isolating valve assembly as claimed in claim 1 wherein the biassing means includes a compression spring.

5. An isolating valve assembly as claimed in claim 1 further comprising coupling means for coupling the valve to a fluid line.

6. An isolating valve assembly as claimed in claim 5 wherein the coupling means comprises a compression fitting and/or a push-fit connector.

7. An isolating valve assembly as claimed in claim 1 wherein each valve plug includes a valve guide stem for guided axial movement within a respective valve body.

8. An isolating valve assembly as claimed in claim 1 wherein the first valve body is attachable to the second valve body by means of a threaded coupling or a bayonet-type coupling.

9. An isolating valve assembly as claimed in claim 1 wherein each valve plug further comprises retaining means to retain the valve plug within the valve body.

10. An isolating valve assembly as claimed in claim 1 further comprising at least one cap associated with the first valve body and/or the second valve body, wherein the or each cap provides a cover to prevent access to the respective valve plug when the isolating valve is in the disconnected configuration.

11. An isolating valve assembly as claimed in claim 1 wherein at least one of the first and second valve bodies includes a valve body having an adjustment arrangement allowing adjustment of an axial length of the valve body.

12. An isolating valve assembly as claimed in claim 11 wherein the second valve body comprises:
i) a cylindrical first valve body portion including an annular detent provided on a threaded inner surface of the first valve body portion dividing the threaded surface into a proximal thread portion and a distal thread portion;
ii) a second valve body portion having a threaded outer surface, threads of which inter-fit the distal threads of the first valve body portion such that the second valve body portion is rotationally movable within first valve body portion to provide axial length adjustment to the second valve body;
iii) a cylindrical valve-housing portion supporting the valve plug of the second valve and including a recess on an external surface thereof into which the annular detent fits to maintain a relative axial positioning between the valve housing portion and the first valve body portion;
wherein adjacent outer surfaces of the valve housing portion and second valve body are unthreaded such that the respective surfaces are able, in operation, to slide over one another.

13. A radiator valve assembly comprising a radiator valve body having an inlet and an outlet and including a radiator valve adjustable between a closed position in which fluid flow through the valve body is prevented and at least one open position in which fluid flow through the valve body is allowed; wherein the radiator valve further comprises an isolating valve assembly as claimed in claim 1.

14. A radiator valve as claimed in claim 13 wherein the isolating valve assembly is provided between the adjustable radiator valve and the radiator, or incorporated into a radiator connection tail or coupler.

15. A connector for connecting two pipes or lines, wherein the connector comprises a first connector portion attachable to a first pipe or line and a second connector portion attachable to a second pipe or line, wherein the first connector portion and second connector portion are connectable to complete a connection between the first and second pipes or lines; wherein the second connector portion includes an adjustment arrangement allowing adjustment of an axial length of the connector; wherein the adjustment arrangement comprises: i) a cylindrical first body portion including an annular detent provided on a threaded inner surface of the first body portion dividing the threaded surface into a proximal thread portion and a distal thread portion; ii) a second body portion having a threaded outer surface, threads of which inter-fit the distal threads of the first body portion such that the second body portion is rotationally movable within first body portion to provide axial length adjustment to the second connector portion; and iii) a cylindrical portion including a recess on an external surface thereof into which the annular detent fits to maintain a relative axial positioning between the cylindrical portion and the first body portion; wherein adjacent outer surfaces of the cylindrical portion and second body portion are unthreaded such that the respective surfaces are able, in operation, to slide over one another.
